(19) United States
(12) Patent Application Publication
(10) Pub. No.: US 2007/0192579 A1
(43) Pub. Date: Aug. 16, 2007

(54) Computer and control method thereof

(75) Inventors: Sung-eun Lee, Suwon-si (KR); Eun-sung Cho, Seoul (KR)

Correspondence Address: STEIN, MCEWEN & BUI, LLP, 1400 EYE STREET, NW, SUITE 300, WASHINGTON, DC, 20005, US

(73) Assignee: Samsung Electronics Co., Ltd., Suwon-si (KR)

(21) Appl. No.: 11/650,480

(22) Filed: Jan. 8, 2007

(30) Foreign Application Priority Data
Feb. 10, 2006 (KR) 2006-13014

(51) Int. Cl. G06F 9/24

(52) U.S. Cl. 713/1

(57) ABSTRACT

A computer comprises a LAN module to support a wake on LAN (WOL) function; a system unit; a user input unit to generate a predetermined input signal according to input of a user; a display unit; and a controller which boots the system unit and disables a function corresponding to the input signal of a user at the computer from the user input unit when the WOL function is activated to boot the system unit. Additionally, a display function of the display unit is disabled when the WOL function is activated to boot the system unit. As a result, an unauthorized person is prevented from operating a computer or viewing information from the display unit when the system unit is booted by a WOL function and a control method thereof.

### CROSS-REFERENCE TO RELATED APPLICATIONS

This application claims all benefits accruing under 35 U.S.C. §119 from Korean Patent Application No. 2006-13014, filed on Feb. 10, 2006, in the Korean Intellectual Property Office, the disclosure of which is incorporated herein by reference.

### BACKGROUND OF THE INVENTION

1. Field of the Invention

The present invention relates to a computer and a control method thereof, and more particularly, to a computer and a control method thereof supporting a Wake on LAN (“WOL”) function.

2. Related Art

Recently, a computer is provided with a Local Area Network (“LAN”) module to support a Wake on LAN (“WOL”) function which has the capability of a remote user to boot or shutdown the computer over a network from a remote location. Typically, a power supplier supplies power to the LAN module and a power controller controls the power supplier to supply power to the LAN module.

In the computer supporting the WOL function, the WOL function is activated so that the computer may be booted remotely. In the conventional computer booted by the WOL function, an unauthorized person located at the computer may access the computer to obtain information. Further, the unauthorized person located at the computer may use a power button to turn off the computer against the wishes of a remote user of the computer.

### SUMMARY OF THE INVENTION

Several aspects and embodiments of the present invention provide a computer that prevents an unauthorized person from operating the computer when the system unit is booted by a WOL function and a control method thereof.

Additional aspects and/or advantages of the invention will be set forth in part in the description which follows and, in part, will be obvious from the description, or may be learned by practice of the invention.

In accordance with an embodiment of the present invention, a computer is provided: a Local Area Network (“LAN”) module to support a Wake on LAN (“WOL”) function; a system unit; a user input unit to generate a predetermined input signal according to input of a user at the computer; and a controller arranged to boot the system unit and to disable a function corresponding to the input signal of the user input unit when the WOL function is activated to boot the system unit.

According to an aspect of the present invention, the computer further comprises a power supplier to supply power to at least one of the system unit and the user input unit, wherein the user input unit comprises a power selection part to select a power on/off state of the power supplier.

According to an aspect of the present invention, the power selection part comprises at least one of a power button and a Multimedia Instant On (“MIO”) button.

According to an aspect of the present invention, the user input unit comprises at least one of a keyboard, a mouse, a touch pad, and a function button.

According to an aspect of the present invention, the computer further comprises a display unit to display an image thereon, wherein the controller disables the display function of the display unit when the WOL function is activated to boot the system unit.

According to an aspect of the present invention, the computer further comprises a lamp to supply light to the display unit; and an inverter to supply power to the lamp, wherein the controller disables the function of inverter, when the WOL function is activated to boot the system unit.

According to an aspect of the invention, the controller comprises a Basic Input/Output System (“BIOS”) to support the system boot function.

According to an aspect of the invention, the controller further comprises a microcontroller to control the BIOS.

In accordance with another embodiment of the present invention, a computer to support a Wake on LAN (“WOL”) function is provided a system unit; a display unit to display an image thereon; and a controller to boot the system unit and to disable a display function of the display unit when the WOL function is activated to boot the system unit.

According to an aspect of the present invention, the computer further comprises a lamp to supply light to the display unit; and an inverter to supply power to the lamp, wherein the controller disables the function of the inverter when the WOL function is activated.

According to an aspect of the present invention, the computer further comprises a Basic Input/Output System (“BIOS”) to support the system boot function.

According to an aspect of the present invention, the computer further comprises a microcontroller to control the BIOS.

In accordance with another embodiment of the present invention, a method of controlling a computer connected to a network provided with a Local Area Network (“LAN”) module to support a Wake on LAN (“WOL”) function, a system unit, and a user input unit, comprises activating, via the network, the WOL function to boot the system unit; booting the system unit; operating the system unit, via the network; monitoring the user input unit for input signals from a user at the computer; receiving an input signal from the user input unit according to input of a user at the computer; and disabling a function corresponding to input of a user at the computer.

According to an aspect of the present invention, the method of control wherein the computer is provided with a display unit further comprises disabling a display function of a display unit requested by a user at the computer.

According to an aspect of the present invention, the method of control further comprises activating, via the network, the WOL function to shutdown the system unit; and shutting down the system unit.

In accordance with another embodiment of the present invention, a method of controlling a computer connected to a network provided with a Local Area Network (“LAN”) module to support a Wake on LAN (“WOL”) function, a system unit, and a display unit, comprises activating, via the network, the WOL function to boot the system unit; booting the system unit; operating the system unit, via the network; and disabling a display function of the display unit requested by a user at the computer.

According to an aspect of the present invention, the method of control further comprises activating, via the network, the WOL function to shutdown the system unit; and shutting down the system unit.

In addition to the example embodiments and aspects as described above, further aspects and embodiments will be apparent by reference to the drawings and by study of the following descriptions.

### BRIEF DESCRIPTION OF THE DRAWINGS

A better understanding of the present invention will become apparent from the following detailed description of example embodiments and the claims when read in connection with the accompanying drawings, all forming a part of the disclosure of this invention. While the following written and illustrated disclosure focuses on disclosing example embodiments of the invention, it should be clearly understood that the same is by way of illustration and example only and that the invention is not limited thereto. The spirit and scope of the present invention are limited only by the terms of the appended claims. The following represents brief descriptions of the drawings, wherein:

FIG. 1 is a control block diagram of a computer, according to an example embodiment of the present invention;

FIG. 2A is a circuit diagram to illustrate how a controller may control an input signal from the user input unit, according to an example embodiment of the present invention;

FIG. 2B is a circuit diagram to illustrate how a controller may control an inverter, according to another example embodiment of the present invention; and

FIG. 3 is a control flow chart of a computer, according to an example embodiment of the present invention.

### DETAILED DESCRIPTION OF THE EMBODIMENTS

Reference will now be made in detail to embodiments of the present invention, examples of which are illustrated in the accompanying drawings, wherein like reference numerals refer to like elements throughout. The embodiments of the invention are not limited to those shown in the drawings, and various changes in form and details may be made therein without departing from the spirit and scope of the present invention. The embodiments are described below in order to explain the present invention by referring to the figures.

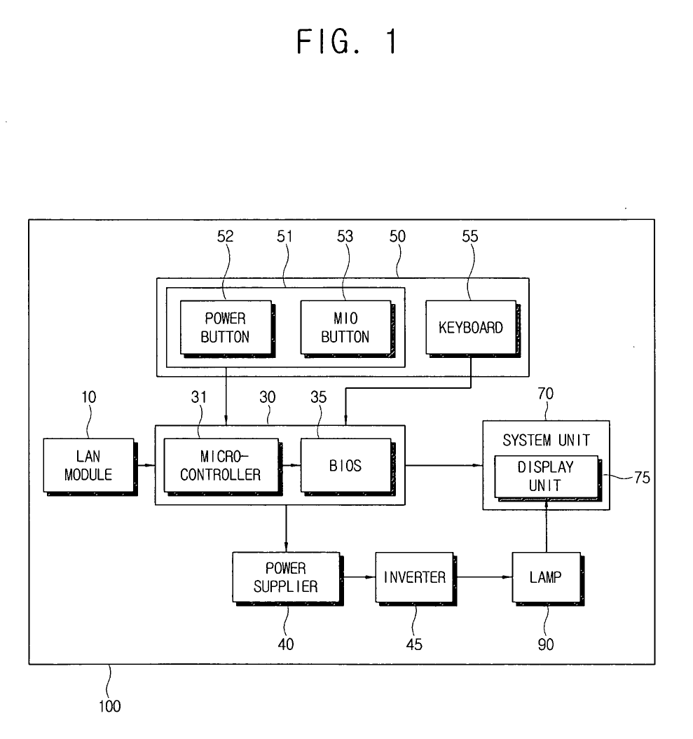

Referring to FIG. 1, a computer 100 according to an example embodiment of the present invention includes a Local Area Network (“LAN”) module 10, a user input unit 50, a system unit 70 and a controller 30 controlling these components. In addition, the computer 100 may further include at least one of a power supplier 40, an inverter 45 and a lamp 90.

The system unit 70 may include additional internal components other than the LAN module 10, the user input unit 50, the power supplier 40, the inverter 45, the lamp 90, and the controller 30. For example, the system unit 70 may include random-access memory (RAM), a hard disk driver, a north bridge, a south bridge, a display unit 75, a central processing unit (“CPU”), and the like.

The display unit 75 receives a video signal to display an image. The display unit 75 may include a display panel (not shown) displaying the image thereon and a panel driver (not shown) processing the inputted video signal to display the image.

The display panel may be provided as a cathode ray tube (“CRT”), a digital light processing (“DLP”) projector, a liquid crystal display (“LCD”), a plasma display panel (“PDP”), etc. The display unit 75 may include a panel driver corresponding to the type of a display panel. For example, when the display panel is provided as a DLP projector, the panel driver includes an optical engine. Another example would be when the display panel is provided as an LCD, the panel driver includes a printed circuit board (PCB) to convert the video signal into a data signal and a gate signal.

The LAN module 10 supports a Wake on LAN (“WOL”) function. The LAN module 10 may include a LAN card (not shown) and a LAN controller (not shown) to control the LAN card. The WOL function allows a remote user to turn on or off the system unit 70, via a network. In other words, the LAN module 10 supporting the WOL function supplies an instruction to the computer 100 to boot or shut down the system unit 70 according to a WOL instruction received through the LAN card from the remote location.

The user input unit 50 provides an input signal to the controller 30 (described later) according to a local user's manipulation. The user input unit 50 may be provided as a plurality of input keys, buttons, etc. to input or to select a predetermined function.

In addition, the user input unit 50 may include various types of input devices such, as a keyboard 55, a mouse, a touch pad, a function button, and the like to operate a predetermined function according to the user's manipulation. The function button may include various types of buttons capable of generating input signals other than the keyboard 55, the mouse, and the touch pad. For example, the function button may be a button provided on one side of a cover of the display unit 75 to select the on/off state of the display unit 75.

The user input unit 50 may also include a power selection part 51 to control the power supplied by the power supplier 40 (described later). The power selection part 51 may include at least one of a power button 51 and a Multimedia Instant On (“MIO”) button 53.

The power supplier 40 supplies power to the respective units of the computer 100 according to the control of the controller 30.

In other words, when the system unit 70 is booted, the power supplier 40 supplies the power to the respective units (described later) of the computer 100. When the system unit 70 is shutdown, the power supplier 40 continues to supply the power to the controller 30 and the LAN module 10, so that the controller 30 can receive the WOL instruction to boot the system unit 70 from the WOL function of the LAN module 10.

The system unit 70 can be booted by the power button 52, the MIO button 53, or the WOL function.

When the system unit 70 is booted on by the power button 52, the power supplier 40 supplies the power to the respective units according to the control of the controller 30.

When the system unit 70 is booted by the MIO button 53, the controller 30 controls the power supplier 40 to supply the power only to a predetermined units among the respective units in the computer 100. For example, when the MIO button 53 is for replaying a DVD, the controller 30 controls the power supplier 40 to supply the power only to the units required to replay the DVD. In other words, the controller 30 may supply the power only to the units that is necessary to replay the DVD, such as a DVD player, the display unit 75, and a signal processor (not shown).

When the system unit 70 is booted by the WOL function, the power supplier 40 supplies the power to the system unit 70 as well as to the LAN module 10 and the controller 30.

The power supplier 40 may convert the power supplied from a power source including one of a battery (not shown) and an AC power adapter (not shown) into power suitable for the respective units of the computer 100. The respective units of the computer 100 refer to the system unit 70, the user input unit 50, the LAN module 10, the controller 30, and the inverter 45.

The inverter 45 converts the power from the power supplier 40 into power for the lamp 90. Specifically, the inverter 45 converts the power from the power supplier 40 into alternating current, adjusts the voltage of the converted alternating current as necessary, and outputs the power to the lamp 90. The lamp 90 is provided to supply light to a display panel of the display unit 75. An image is displayed on the display panel only when the display panel is supplied with light from the lamp 90.

The controller 30 controls the system unit 70 to operate when the WOL function is activated. The controller 30 may include a Basic Input/Output System (“BIOS”) 35 supporting a booting function and a microcontroller 31 controlling the BIOS 35. The microcontroller 31 determines whether an input signal for the power on/off is received from the power selection part 51 or a WOL function activation signal is received through the LAN module 10, even when the system unit 70 is not booted. In addition, the microcontroller 31 allows the BIOS 35 to perform the booting function according to the WOL function activation signal or the input signal for the power on/off.

In an example embodiment of the present invention, when the WOL function is activated according to a WOL function activation signal received by the LAN Module 10, the controller 30 disables a function input from the user input part 50. The WOL function activation signal instructs the controller 30 to control the BIOS 35 to boot the system unit 70.

The controller 30 may disable the function of the input from the user input unit 50 by instructing the power supplier 40 to not apply power to the user input part 50. Alternatively, the controller 30 may disable the function of the input from the user input unit 50 by not responding to input signals from the user input unit 50.

In the example embodiment of the present invention, the user input unit 50 includes the power selection part 51. The controller 30 may disable the function corresponding to the input signal generated by a user operating the power selection part 51 when the system unit 70 was booted according to the WOL function. Thus, when the system unit 70 is booted according to the WOL function, the system unit 70 is not shut down when a user operates the power selection part 51. Accordingly, an unauthorized local user shutting down the system unit 70 may be prevented when the system unit 70 is booted according to the WOL function.

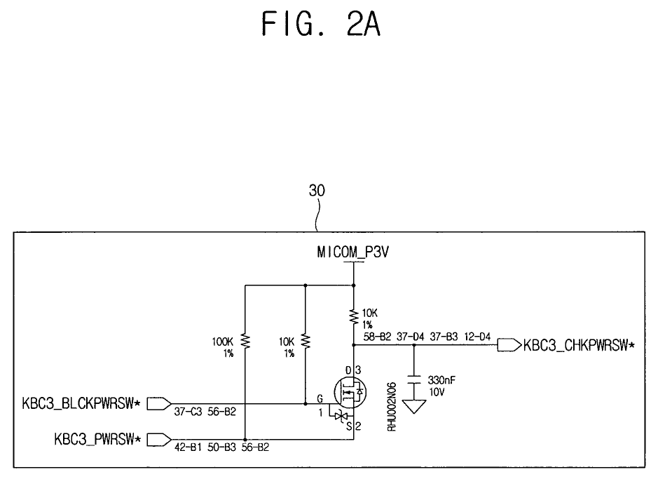

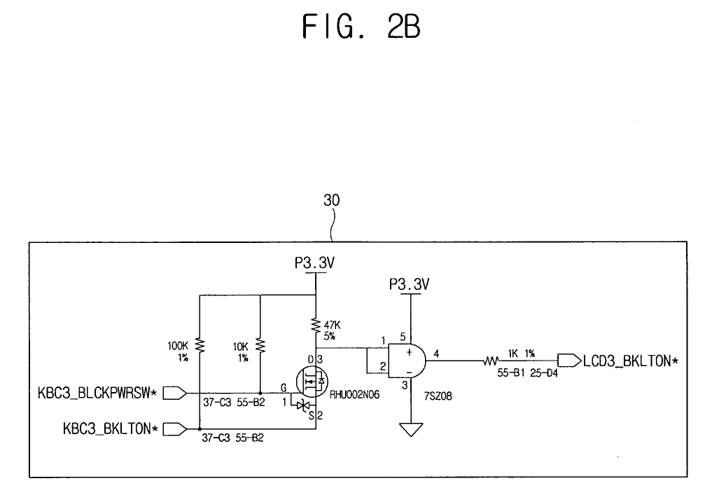

FIG. 2A is a circuit diagram to illustrate how the controller 30 can control an input signal from the user input unit 50 according to an example embodiment of the present invention. Specifically, FIG. 2A details how the controller 30 can disable the function of the input signal from the power selection 51 of the user input part 50 depending on whether or not the system unit 70 has been booted by the WOL function.

In FIG. 2A, KBC3_BLCKPWRSW is a signal from the microcontroller 31 which is low when the system unit 70 has been booted by the WOL function and is high when the system unit 70 has not been booted by the WOL function. KBC3_PWRSW is an input signal from the power selection part 51 that is low when the power selection part 51 is operated by a user at the computer 100 and high when the power selection part 51 is not operated. KBC3_CHKPWRSW is an output signal determined according to the signal from the microcontroller 31 and the input signal from the power selection part 51.

In an example embodiment of the present invention as shown in FIG. 2A, KBC3_PWRSW is normally held high by a pull up resistor. When a local user operates the power selection part 51 (such as by pressing a power switch), KBC3_PWRSW becomes low.

When the system unit 70 has not been booted by the WOL function, the microcontroller 31 holds KBC3_BLCKPWRSW high. This allows KBC3_CHKPWRSW to be determined according to whether a low signal is applied from the KBC3_PWRSW. Namely, when a low signal is applied from the KBC3_PWRSW, the microcontroller 31 determines that the power selection part 51 has been operated by the local user, and then the microcontroller 31 adjusts the power on/off state of each respective unit of the computer 100. This allows a local user to control the on/off state of the system unit 70 when the system unit 70 has not been booted by the WOL function.

If the microcontroller 31 determines that the system unit 70 was booted by the WOL function, the microcontroller 31 holds KBC3_BLCKPWRSW low. Because of this, the output KBC3_CHKPWRSW is low regardless of the value of the input KBC3_PWRSW. Accordingly, when the system unit 70 was booted by the WOL function, the function of the power selection part 51 is disabled and the input signal from the power selection part 51 is not applied to the microcontroller 31. This prevents a local user from controlling the on/off state of the system unit 70 when a remote user has booted the system unit 70.

In the aforementioned description with reference to FIG. 2A, the microcontroller 31 receives the signal KBC3_CHKPWRSW and controls the signal applied to KBC3_BLCKPWRSW. In an alternative embodiment of the present invention, however, the BIOS 35 may perform the same operation instead of the microcontroller 31.

Further, the circuit diagram shown in FIG. 2A is just one example embodiment of the present invention, and the present invention is not limited thereto. Other circuit diagrams which disable the function of the power selection part 51 when the system unit 70 is booted by the WOL function would also be within the scope of the present invention.

When the user input unit 50 is provided as a button, such as the keyboard 55, a mouse, a touch pad, or a function button to operate a predetermined function, the controller 30 may disable the a function corresponding to the input signal from user input unit 50 when the system unit 70 is booted by the WOL function. Accordingly, the unauthorized user is unable to operate the computer when the system unit 70 is booted according to the WOL function.

According to an example embodiment of the present invention, when the WOL function is activated, the controller 30 disables the display function of the display unit 75. One method to disable the display function of the display unit 75 is for the controller 30 to control the power supplier 40 so as not to supply the power to at least one of the display panel and the panel driver of the display unit 75. Alternatively, the controller 30 may block the image signal which forms the image on the display unit 75. Further, the controller 30 may control the power supplier 40 so as to not supply the power to the inverter 45, or may prevent the power from the inverter 45 from being applied to the lamp 90. In addition, the controller 30 may store a reference image and control the display unit 75 to display only the stored reference image. Additional methods would also be within the scope of the present invention to disable the display function of the display unit 75.

Accordingly, as either an image is not displayed on the display unit 75 or a reference image is displayed, a local user would either not recognize that the system unit 70 is booted or would recognize the system unit 70 has been remotely booted by the WOL function, and would therefore not attempt to operate the computer 100. In addition, when a remote user operates the computer 100, a local user would not be able to obtain information from the computer, as the display function of the display unit 75 would be disabled.

FIG. 2B is a circuit diagram to illustrate how the controller 30 can control and disable the function of the inverter 45 according to another example embodiment of the present invention.

In FIG. 2B, LCD3_BKLTON is an output signal informing the microcontroller 31 whether a signal to supply the power to the lamp 90 has been input. KBC3_BLCKPWRSW is a signal from the microcontroller 31 which is low when the system unit 70 was booted by the WOL function and high when the system unit 70 was not booted by the WOL function. KBC3_BKLTON is an input signal from the user input unit 50 indicating if a local user has input, such as by pressing a key, a signal to supply the power to the lamp 90.

According to an example embodiment of the present invention, KBC3_BKLTON is normally high. When a local user operates the user input unit 50 to enable the lamp 90, KBC3_BKLTON becomes a low logic signal.

When the system unit 70 has not been booted by the WOL function, the microcontroller 31 places the KBC3_BLCKPWRSW signal high. This allows the output signal LCD3_BKLTON to be determined according to whether a low signal from the KBC3_BKLTON is input. When KBC3_BKLTON is low, the microcontroller 31 determines that a user has input a signal to supply the power to the lamp 90, and the microcontroller 31, via the power supplier 40, controls the inverter 45 to supply power to the lamp 90.

When the system unit 70 was booted by the WOL function, the microcontroller 31 holds the KBC3_BLCKPWRSW signal low. Because of this, the output signal LCD3_BKLTON is low regardless of a low signal or a high signal from KBC3_BKLTON. Accordingly, when the system unit 70 is booted by the WOL function, the function of the input signal from the user input unit 50 to supply power to the lamp 90 is disabled and not applied to the microcontroller 31.

In the aforementioned description with reference to FIG. 2B, the microcontroller 31 receives the signal LCD3_BKLTON and controls the signal KBC3_BLCKPWRSW. In an alternative embodiment of the present invention, however, the BIOS 35 may perform the operation instead of the microcontroller 31.

In FIG. 2B, both input terminals 1 and 2 of an AND gate are designed to be applied with the same signal, but this illustrated design is only an example embodiment. In an alternative embodiment, the first input terminal 1 of the AND gate could be a low signal from the microcontroller 31 when the system unit 70 is booted by the WOL function. Other circuit diagrams which disable the function of the inverter 45 when the system unit 70 is booted by the WOL function would also be within the scope of the present invention. Additionally, other elements could also be employed instead of an AND gate.

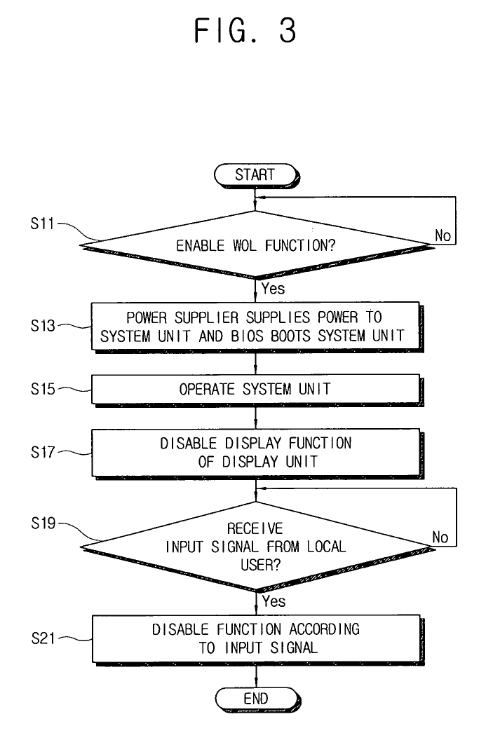

Referring to FIG. 3, when the computer 100 receives the WOL function signal to boot the system unit 70 from the LAN module 10 (S11), the computer outputs the received WOL function activation signal to the controller 30. Then, the controller 30 boots the system unit 70. In other words, the controller 30 controls the power supplier 40 to supply the power to the system unit 70, and the BIOS 35 of the controller 30 boots the system unit 70 (S13). When the system unit 70 has been booted, the system unit 70 is operable by a remote user (S15).

When the system unit 70 is booted by the WOL function, the controller 30 disables the display function of the display unit 75 (S17). The display function can be disabled by the controller 30 controlling the inverter 45 to not supply the power to the lamp 90 which supplies light to the display panel of the display unit 75. In an alternative embodiment of the present invention, the controller 30 may disable the display function of the display unit 75 by controlling a signal processor (not shown) so as to not output the image signal to the display panel of the display unit 75.

When a local user inputs a signal via the user input unit 50 (S19), the controller 30 may disable the function of the input signal (S21). Referring to the example embodiment of the present invention shown in FIG. 1, the user input unit 50 includes the power selection part 51. In addition, the user input unit 50 may include input methods such as a keyboard 55, a mouse, a touchpad, and the like. When the system unit 70 is booted from a WOL function, the controller 30 may disable the functions of the input signals generated by these input devices.

In addition, the user input unit 50 may include an on/off button for the display unit 75, and when the system unit 70 is booted from a WOL function, the controller 30 may disable the function of the on/off button of the display unit 75.

While there have been illustrated and described what are considered to be example embodiments of the present invention, it will be understood by those skilled in the art and as technology develops that various changes and modifications, may be made, and equivalents may be substituted for elements thereof without departing from the true scope of the present invention. Many modifications, permutations, additions, and sub-combinations may be made to adapt the teachings of the present invention to a particular situation without departing from the scope thereof. For example, the embodiments of the present invention discussed a computer system that boots and shuts down a system unit, but the present invention could also be embodied in a system unit that goes into a hibernation state rather than a shutdown state. Alternatively, the LAN module could be part of a wireless network card, and the network from which the WOL function activation signal is received could therefore be wireless. In addition, various components of the circuit diagrams shown in FIG. 2A and FIG. 2B, such as the transistor and resistors can be integrated into a single control unit, or alternatively, can be implemented in software or hardware, such as, for example, a field programmable gate array (“FPGA”) and an application specific integrated circuit (“ASIC”). As such, it is intended that the processes described herein be broadly interpreted as being equivalently performed by software, hardware, or a combination thereof. Accordingly, it is intended, therefore, that the present invention not be limited to the various example embodiments disclosed, but that the present invention includes all embodiments falling within the scope of the appended claims.

What is claimed is:

1. A computer comprising:
a Local Area Network (“LAN”) module to support a Wake on LAN (“WOL”) function;
a system unit;
a user input unit to generate a predetermined input signal according to input of a user at the computer; and
a controller arranged to boot the system unit and to disable a function corresponding to the input signal of the user input unit, when the WOL function is activated to boot the system unit.

2. The computer according to claim 1, further comprising:
a power supplier to supply power to at least one of the system unit and the user input unit,
wherein the user input unit comprises a power selection part to select a power on/off state of the power supplier.

3. The computer according to claim 2, wherein the power selection part comprises at least one of a power button and a Multimedia Instant On (“MIO”) button.

4. The computer according to claim 2, wherein the user input unit comprises at least one of a keyboard, a mouse, a touch pad, and a function button.

5. The computer according to claim 2, further comprising:
a display unit to display an image thereon,
wherein the controller disables the display function of the display unit when the WOL function is activated to boot the system unit.

6. The computer according to claim 5, further comprising:
a lamp to supply light to the display unit; and
an inverter to supply power to the lamp,
wherein the controller disables the function of the inverter, when the WOL function is activated to boot the system unit.

7. The computer according to claim 1, wherein the controller comprises a Basic Input/Output System (“BIOS”) to support the system unit boot function.

8. The computer according to claim 7, wherein the controller further comprises a microcontroller to control the BIOS.

9. A computer to support a Wake on LAN (“WOL”) function, comprising:
a system unit;
a display unit to display an image thereon; and
a controller to boot the system unit and to disable a display function of the display unit, when the WOL function is activated to boot the system unit.

10. The computer according to claim 9, further comprising:
a lamp to supply light to the display unit; and
an inverter to supply power to the lamp,
wherein the controller disables the function of the inverter, when the WOL function is activated to boot the system unit.

11. The computer according to claim 9, wherein the controller comprises a Basic Input/Output System (“BIOS”) to support the system boot function.

12. The computer according to claim 11, wherein the controller further comprises a microcontroller to control the BIOS.

13. A method of controlling a computer connected to a network provided with a Local Area Network (“LAN”) module to support a Wake on LAN (“WOL”) function, a system unit, and a user input unit, comprising:
activating, via the network, the WOL function to boot the system unit;
booting the system unit;
operating the system unit, via the network;
monitoring the user input unit for input signals from a user at the computer;
receiving an input signal from the user input unit according to input of a user at the computer; and
disabling a function corresponding to the input signal from the user at the computer.

14. The control method according to claim 13, wherein the computer is provided with a display unit, further comprises disabling a display function of a display unit requested by the user at the computer.

15. The method of controlling a computer according to claim 13, further comprising:
activating, via the network, the WOL function to shutdown the system unit; and
shutting down the system unit.

16. A method of controlling a computer on a network provided with a Local Area Network (“LAN”) module to support a Wake on LAN (“WOL”) function, a system unit, and a display unit comprising:
activating, via the network, the WOL function to boot the system unit;
booting the system unit;
operating the system unit, via the network; and
disabling a display function of the display unit requested by a user at the computer.

17. The method of controlling a computer according to claim 16, further comprising:
activating, via the network, the WOL function to shutdown the system unit; and
shutting down the system unit.
